(19) United States
(12) Patent Application Publication
(10) Pub. No.: US 2014/0092974 A1
(43) Pub. Date: Apr. 3, 2014

(54) System and Method for Motion Estimation for Large-Size Block

(71) Applicant: Feng Zhou, Fremont, CA (US)

(72) Inventor: Feng Zhou, Fremont, CA (US)

(73) Assignee: FutureWei Technologies, Inc., Plano, TX (US)

(21) Appl. No.: 13/633,738

(22) Filed: Oct. 2, 2012

(51) Int. Cl. H04N 7/32

(52) U.S. Cl. 375/240.16; 375/E07.123

(57) ABSTRACT

A method and apparatus are disclosed for providing motion estimation (ME) for large-size blocks of image data during image processing using small-size block processing logic. An embodiment method includes obtaining a large-size block for ME processing and dividing the large-size block into a plurality of small-size blocks. The large-size block comprises an integer multiple of the small-size blocks. The small-size blocks are then processed in parallel using a small-size block ME processing algorithm. An embodiment apparatus includes a processor configured to implement the method for large-size block ME processing using small-size block ME processing logic, and a shared memory register for storing at different times the 16×16 blocks.

### TECHNICAL FIELD

The present invention relates to a system and method for image processing, and, in particular embodiments, to a system and method for motion estimation for large-size block.

### BACKGROUND

Video coding deals with representation of video data, for storage and/or transmission, for example for digital video. Video coding can be implemented with captured video as well as computer generated video and graphics. Goals of video coding are to accurately and compactly represent the video data, provide navigation of the video (i.e., search forwards and backwards, random access, etc.) and other additional author and content benefits, such as text (subtitles), meta information for searching/browsing and digital rights management. Video data is typically processed in blocks of data bytes or bits, where multiple blocks form an image frame. Video coding can be performed by a processor on the transmitting end (also referred to as an encoder) to compress original video into a format suitable for transmission. Video coding can also be performed by a trans-coder that converts digital-to-digital data from one encoding format to another. The encoder and trans-coder may include software components implemented via a processor or firmware. Video coding functions include motion estimation, which is a process of determining motion vectors that describe the transformation from one two-dimensional (2D) image to another.

High-Efficiency Video Coding (HEVC) is a recent video coding standard that is being developed by the Joint Collaborative Team on Video Coding (JCT-VC) of ITU-T and ISO/IEC. The HEVC standard is incorporated herein by reference. In HEVC, the size of processed blocks (for an image frame) is relatively large, such as 64×64 blocks of data units. The processing of large-size blocks for ME is a computational-intensive operation, which can substantially reduce computation performance and/or increase hardware or chip cost and complexity.

### SUMMARY

In one embodiment, a method for motion estimation (ME) for a large-size block of image data is disclosed. The method includes obtaining a large-size block for ME processing and dividing the large-size block into a plurality of small-size blocks. The method also includes processing the small-size blocks in parallel using a small-size block ME processing algorithm. The large-size block comprises an integer multiple of the small-size blocks. In an example, the small-size blocks are 16×16 blocks of data bytes.

In another embodiment, an apparatus for implementing ME for a large-size block of image data is disclosed. The apparatus comprises a processor configured to obtain a 64×64 block of bytes of image data for ME processing and divide the 64×64 block into a plurality of 16×16 blocks of data bytes. The processor is also configured to process the 16×16 blocks in parallel using a ME processing algorithm for 16×16 blocks.

In yet another embodiment, a network component for video coding is disclosed. The network component comprises a processor configured to obtain a large-size block of bytes of image data for motion estimation (ME), divide the large-size block into a plurality of small-size blocks of bytes that comprise a same data, and process the small-size blocks for ME individually in parallel using a corresponding small-size block ME processing algorithm. The network component further comprises a single shared register for storing at different times the small-size blocks.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a current ME processing scheme for 64×64 blocks;

FIG. 2 illustrates an efficient ME processing scheme for large-size blocks according to an embodiment;

FIG. 3 is a flowchart of a method for large-size block processing using small-size block processing logic according to an embodiment; and

FIG. 4 is a schematic diagram of a processing system that can be utilized to implement various embodiments.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

In recent video compression standard “HEVC”, large-size blocks of image data that belong to image frames, such as 64×64, 64×32, 32×64, 32×32, 32×16, and 16×32 blocks, are used in ME. The blocks comprise bytes of data and may be represented in the form of matrices. Compared to small-size blocks (e.g., 16×16 blocks or smaller), the large-size blocks require more overhead for ME, such as in number of processor cycles (i.e., clock cycles). For example, processing a 16×16 block may take 16 cycles before starting actual motion search calculation. Using the same ME architecture in video encoder chips, a 64×64 block typically requires 64 cycles to start the actual motion search calculation. Generally, ME is performed for a plurality of lines for the same block, for example for multiples of 16 lines. Thus, the ME overhead (in number of cycles) is proportional to both the block size and the number of lines for motion search. For instance, when there are 64 lines to be processed for a 64×64 block, the number of cycles needed for ME is equal to 64×64 or 4096 cycles.

Using a typical video processing chip and logic, such as based on a 1080P60 HD format, each 64×64 block may have only 6,400 cycles that can be used for overall ME computing. Thus, the actual computing time for ME, e.g., for actual motion search calculation, is reduced significantly after using 4096 of the cycles for line motion searches (for 64 lines per block). The cycles that remain for performing actual motion search calculation may be limited and reduce ME performance in comparison to the case of small-size blocks (e.g., 16×16 blocks). To compensate for this overhead, more complex hardware or chip logic may be used, which increases chip cost and resource (e.g., power) consumption. Thus, improving motion estimation efficiency and simplifying chip logic for large-size blocks is beneficial to significantly improve performance and reduce chip cost for video coding and processing.

To decrease the time for line motion search and the chip cost and improve ME performance for large-size blocks, embodiments are disclosed herein that use fewer cycles than the current approach to efficiently process large-size blocks. An embodiment method may be implemented by an apparatus, a processor (e.g., an encoder), or a network component and includes dividing a large-size block into multiple equivalent 16×16 blocks, and then processing the individual 16×16 blocks using a standard or current ME processing method for such small-size blocks. For example, a 64×64 block may be divided into 16 small-size 16×16 blocks that represent the same data, where each 16×16 block needs 16 cycles of overhead for ME. As such, the resulting total number of cycles for processing the data of the 64×64 block becomes equal to 16×64 or 1024 cycles instead of 64×64 or 4096 cycles, which is required using standard large-size block ME processing. Using this method, the overhead for ME in number of cycles may be reduced by a ratio of about ¾ (i.e., a 75% of overhead reduction). The resulting freed-up cycles may be used for actual motion search calculation, which results in improving ME efficiency and performance. Additionally or alternatively, this reduced overhead may reduce chip complexity and logic, cost, and power consumption.

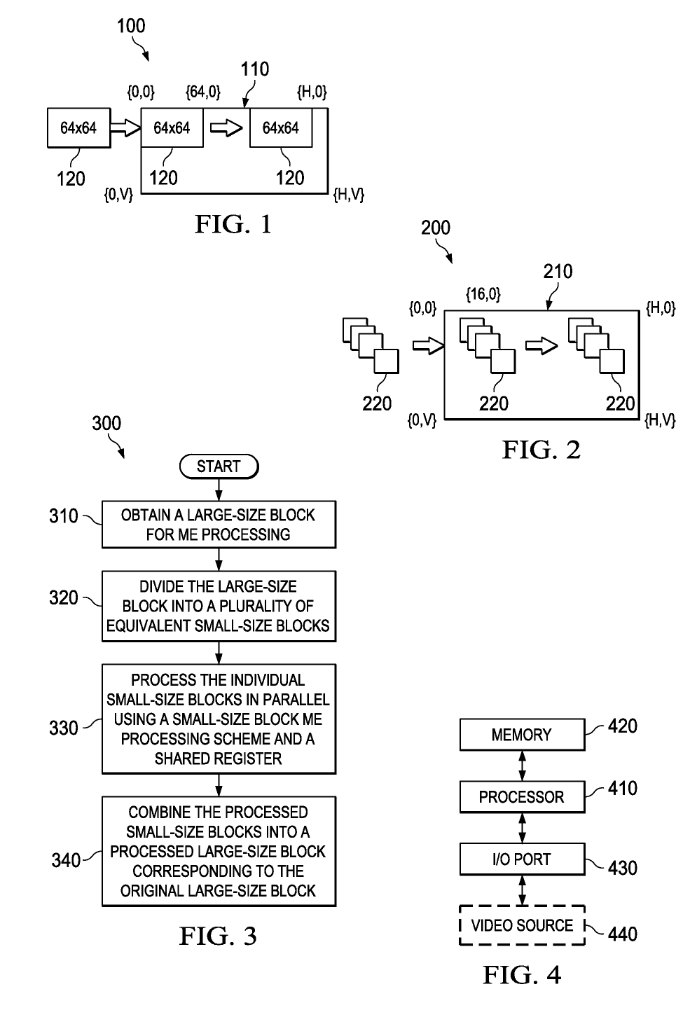

FIG. 1 illustrates a ME processing scheme 100 for 64×64 blocks that is currently used for the HEVC standard. For instance, the ME processing scheme 100 may be implemented at an encoder to encode video data before transmission or at a trans-coder. In the scheme 100, a 64×64 block 120 may be processed for ME in an image frame or an image frame portion 110. The image frame portion 110 may comprise a matrix of H×V (H and V are integers) data units, e.g., data bytes, where the top-left corner may have the coordinates {0,0} and the bottom-right corner may have the coordinates {H,V}. For example, each data unit or byte represents a pixel in the image frame. The ME process comprises determining a motion vector that describes the movement of blocks in the image frame portion 110 (or between image frames). The motion vector describes the translation or movement of the 64×64 block 120 along a line or direction in the image frame portion 110, for example from left to right of the image frame portion 110.

The ME processing scheme 100 typically uses 64 processor cycles to perform one line motion search for a 64×64 block. The number of lines that are considered for ME may correspond to the number of data rows of the image frame portion 110, i.e., V. Thus, the total number of cycles for line motion searches is equal to V×64 cycles. The number of data rows, V, may be a multiple of 16. For example, when V is equal to 16, the total number of cycles for line motion searches is equal to 16×64 or 1024 cycles, and when V is equal to 64, the total number of cycles is equal to 64×64 or 4096 cycles. Thus, the overhead for ME may substantially increase as the block size increases and as the number of line motion searches or V increases. Additionally, the scheme 100 uses a 64×64 8-bit register, i.e., a total of 64×64×8 or 32K bits, to store the 64×64 block data for processing. Due to the requirements above, it is more feasible to implement the scheme 100 via hardware, e.g., using a HEVC standard chip, with or without software, such as in the case of real-time processing/communications applications.

FIG. 2 illustrates an embodiment ME processing scheme 200 for large-size blocks. The ME processing scheme 200 may be implemented as part of HEVC coding to improve efficiency, time, and cost in comparison to current ME processing schemes for large-size blocks (e.g., the ME processing scheme 100). The improvements may allow implementing the scheme using simple chip cost and logic. In the scheme 200, a large-size block, such as a 64×64 block, may be processed for ME in an image frame or an image frame portion 210. The image frame portion 210 may be similar to the image frame portion 110 and comprise a matrix of HxV data units, where the top-left corner may have the coordinates {0,0} and the bottom-right corner may have the coordinates {H,V}.

The ME processing scheme 200 may first divide the large-size block into a plurality of equivalent small-size blocks, for instance a plurality of 16×16 blocks and process the equivalent 16×16 blocks in parallel using a current small-size block ME scheme for ME in existing video coding standards, which is referred to as 16×16 micro-block ME . For example, a 64×64 block may be processed by dividing the block into 16 small-size 16×16 blocks and then processing the individual 16×16 blocks in parallel, e.g., at about the same time using time division multiplexing. Each 16×16 block may be processed using an efficient existing or standard ME processing scheme for small-size 16×16 blocks. Each 16×16 block may need 16 line motion searches, where one line motion search requires 16 processor cycles for ME. Since the resulting 16 small-size 16×16 blocks are processed in parallel, the 16 line motion searches can be implemented at about the same time. As such, the total number of cycles for all the blocks is equal to 16×16 (or 256) cycles and the overhead for ME may be substantially reduced (by about 75%) in comparison to the ME processing scheme 100. The savings in overhead (i.e., in number of cycles) may be used for actual motion search calculation to improve processing efficiency and performance. The savings in overhead may also translate into savings in chip cost and power consumption, for example while maintaining the same level or performance of the current scheme 100.

Additionally, the scheme 200 may use a 16×16 8-bit register, i.e., a total of 16×16×8 (or 2K) bits, to store the 16×16 block data for processing. Since the 16 small-size 16×16 blocks are processed in parallel, e.g., via time vision multiplexing, and a single 2K bit register can be shared to store all the blocks at different times. This corresponds to a ratio 15/16 in register size savings in comparison to the scheme 100. The savings in register size or memory further reduce cost and power consumption and simplify chip logic.

FIG. 3 illustrates an embodiment method 300 for large-size block ME processing using small-size block ME processing logic. The method 300 may correspond to or may be part of the scheme 200 and may be implemented by a video encoder or trans-coder. The encoder or trans-coder may be located at or part of a network component that transmits and/or receives data, including video or image data in a network. For example, the network component may be a data server, a router, or any network node that is configured to process and forward data, such as in the form of packets. Alternatively, the network component may be a customer premises equipment (CPE), such as a set-top box, a cable receiver, or a modem. The method 300 begins at step 310, where a large-size block is obtained for ME processing. For example, the large-size block may be a 64×64, 64×32, 32×64, 32×32, 32×16, or 16×32 block. At step 320, the large-size block is divided into a plurality of equivalent small-size blocks, such as an integer multiple of 16×16 blocks. The resulting small-size blocks combined comprise the same data as the original large-size block. For example, a large-size 64×64 block is divided into 16 small-size 16×16 blocks. At step 330, the individual small-size blocks are processed in parallel using a small-size block ME processing algorithm, which may be a standard or known algorithm, and using a single shared register. For example, the 16 small-size 16×16 blocks are processed using a shared 2K register and time division multiplexing. The processing includes performing a plurality of line motion searches and motion search calculation for each 16×16 block. At step 340, the processed small-size blocks are combined into a processed large-size block corresponding to the original large-size block. The resulting large-size block may then be further processed to complete video coding.

FIG. 4 illustrates a processing system 400 that can be utilized to implement methods of the present disclosure. The processing system 400 may be part of or may correspond to a network component, e.g., a server or a router in a network or data center or a CPE at a customer site. The main processing is performed in a processor 410, which can be a microprocessor, digital signal processor or any other appropriate processing device. The processor 410 may be implemented as one or more CPU chips, cores (e.g., a multi-core processor), field-programmable gate arrays (FPGAs), application specific integrated circuits (ASICs), and/or digital signal processors (DSPs), and/or may be part of one or more ASICs. The processor 410 may be configured to implement or support the scheme 200 and the method 300. In one embodiment, the processor 410 can be used to implement various ones (or all) of the functions discussed above. For example, the processor 410 can serve as a specific functional unit at different times to implement the subtasks involved in performing the techniques of the present invention. Alternatively, different hardware blocks (e.g., the same as or different than the processor 410) can be used to perform different functions. In other embodiments, some subtasks are performed by the processor while others are performed using a separate circuitry.

Program code, e.g., the code implementing the algorithms disclosed above, and data can be stored in a memory 420. The memory 420 can be read only memory (or ROM), a local memory such as DRAM or mass storage such as a hard drive, optical drive or other storage (which may be local or remote). While the memory 420 is illustrated functionally with a single block, it is understood that one or more hardware blocks can be used to implement this function. The memory 420 may comprise the shared register that is used to process the small-size blocks in the scheme 200 and the method 300. FIG. 4 also illustrates an Input/Output (I/O) port 430, which can be used to provide the video to and from the processor. A video source 440 (the destination is not explicitly shown) is illustrated in dashed lines to indicate that it is not necessary part of the system. For example, the video source 440 can be linked to the system by a network such as the Internet or by local interfaces (e.g., a USB or LAN interface).

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for motion estimation (ME) for a large-size block of image data, the method comprising:
obtaining a large-size block for ME processing;
dividing the large-size block into a plurality of small-size blocks; and
processing the small-size blocks in parallel using a small-size block ME processing algorithm,
wherein the large-size block comprises an integer multiple of the small-size blocks.

2. The method of claim 1, wherein the small-size blocks are 16×16 blocks of data bytes.

3. The method of claim 1, further comprising combining the processed small-size blocks into a processed large-size block corresponding to the large-size block.

4. The method of claim 1, wherein the small-size blocks combined comprise a same image data of the large-size block.

5. The method of claim 1, wherein the small-size blocks are processed using a single shared register that stores each one of the small-size blocks at a time.

6. The method of claim 1, wherein processing the small-size blocks in parallel comprises processing the small-size blocks at about a same time using time division multiplexing.

7. The method of claim 1, wherein the large-size block is a 64×64 block, and wherein the 64×64 block is divided into 16 of the small-size blocks.

8. The method of claim 7, wherein the small-size block ME processing algorithm is a current standard 16×16 block ME processing algorithm.

9. An apparatus for implementing motion estimation (ME) for a large-size block of image data, the apparatus comprising:
a processor configured to:
obtain a 64×64 block of bytes of image data for ME processing;
divide the 64×64 block into a plurality of 16×16 blocks of data bytes; and
process the 16×16 blocks in parallel using a ME processing algorithm for 16×16 blocks.

10. The apparatus of claim 9, wherein the processor is configured to process each of the 16×16 blocks using 16 clock cycles for 16 line motion searches and process a total number of 16 of the 16×16 blocks using 256 clock cycles.

11. The apparatus of claim 9, wherein the processor is configured to process each of the 16×16 blocks using 64 clock cycles for 64 line motion searches and processes a total number of 16 of the 16×16 blocks using 1024 clock cycles.

12. The apparatus of claim 9, wherein the processor is configured to use a maximum number of clock cycles for ME processing that includes a plurality of first clock cycles for line motion searches for the 16×16 blocks and a plurality of second clock cycles for actual motion search calculation.

13. The apparatus of claim 9, wherein the processor is based on a 1080P60 HD format and is configured to use a maximum number of 6,400 clock cycles for ME processing.

14. The apparatus of claim 9 further comprising a shared memory register for storing the 16×16 blocks at different times, wherein the shared memory register is configured to store the 16×16 blocks using time division multiplexing.

15. The apparatus of claim 14, wherein the memory register is a 16×16 8-bit register that stores a total of 2048 bits.

16. A network component for video coding, the network component comprising:
a processor configured to:
obtain a large-size block of bytes of image data for motion estimation (ME);
divide the large-size block into a plurality of small-size blocks of bytes that comprise a same data; and
process the small-size blocks for ME individually and in parallel using a small-size block ME processing algorithm; and
a single shared register for storing at different times the small-size blocks.

17. The network component of claim 16, wherein the processor is configured to process the small-size blocks individually using the small-size block ME processing algorithm to reduce a number of clock cycles of the processor by 75% in comparison to processing the large-size block using a large-size block ME processing algorithm.

18. The network component of claim 17, wherein the processor is configured to reduce the number of clock cycles to improve performance of ME and actual motion search calculation.

19. The network component of claim 17, wherein the processor is configured to reduce the number of clock cycles to simplify logic and cost of the processor.

20. The network component of claim 16, wherein a size of the shared register for storing at different times the small-size blocks is reduced in comparison to a second register for storing the large-size block.
